(19) United States
(12) Patent Application Publication
(10) Pub. No.: US 2006/0034549 A1
(43) Pub. Date: Feb. 16, 2006

(54) Camera system, camera head and camera main frame

(75) Inventors: Hiroshi Tanaka, Asaka (JP); Mikio Watanabe, Asaka (JP); Kazunori Suemoto, Asaka (JP); Hirofumi Horii, Asaka (JP); Satoshi Nakamura, Asaka (JP); Kentaro Tokiwa, Asaka (JP); Takehiko Senba, Asaka (JP); Keiichiro Takahashi, Asaka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/202,260

(22) Filed: Aug. 12, 2005

(30) Foreign Application Priority Data
Aug. 12, 2004 (JP) 2004-235394

(51) Int. Cl. G06K 9/20

(52) U.S. Cl. 382/312

(57) ABSTRACT

A plurality of sorts of camera heads being different from one another in specification of the imaging device is each provided with JPEG compression section so that the camera head outputs an image signal, which is subjected to a JPEG compression in compression rate of the mode “fine”, in form of a predetermined format. The provision of a camera main frame, which is capable of performing an image processing through entry of the signal subjected to the JPEG compression in compression rate of the mode “fine”, makes it possible to implement a camera system capable of performing the image processing by the JPEG compression and expansion section and the signal processing section of the camera main frame regardless of the camera head.

### BACKGROUND OF THE INVENTION

1. Field of the Invention

The present invention relates to a camera system having a plurality of sorts of camera heads each comprising an image taking optical system and an imaging device, which generates an image signal, the camera heads being different from one another in specification of the imaging device, and a camera main frame for receiving the image signal from the camera head that is mounted on an exchangeable basis to perform an image recording processing for a recording medium, and/or to perform an image display processing for an image display screen, and the camera head and the camera main frame, which constitute the camera system.

2. Description of the Related Art

There is proposed a camera system wherein when a plug-in unit, in which an imaging device and an image taking optical system are formed in one united body, is mounted on a camera main frame, information of the plug-in unit is transmitted to the camera main frame, so that the image taking optical system of the plug-in unit can perform photography (cf. Japanese Patent Application Laid Open Gazette TokuKai Hei. 8-172561). In this manner, there is implemented the camera system that permits an exchange of the image taking optical system or the image taking lens through simply mounting the plug-in unit on the camera main frame. This feature makes it possible to very simplify handling of the camera system, so that an ordinary person, but not a specialist or an expert, can easily exchange the image taking lens.

In the similar ones, there is proposed a camera system having a camera head comprising an image taking optical system and an imaging device, and a camera main frame for receiving an image signal from the camera head that is detachably mounted to perform a signal processing (cf. Japanese Patent Application Laid Open Gazette TokuKai 2000-175089, and Japanese Patent Application Laid Open Gazette TokuKai 2000-32308).

In such a camera system, there is provided a system in which with respect to both the camera head and the camera main frame, there are prepared various grades of items, and selection of any one of the camera head and selection of any one of the camera main frame permit it to easily combine the camera head and the camera main frame. This feature makes it to provide a camera system that meets any user's needs (cf. Japanese Patent Application Laid Open Gazette TokuKai 2000-50138).

Japanese Patent Application Laid Open Gazette TokuKai 2000-50138 discloses a camera system in which in order to implement a combination of the camera head and the camera main frame as much as possible, information as to the structure of the camera head is transferred from the camera head to the camera main frame side so that the adaptive processing is carried out. However, the imaging device is full of variety, and thus the number of pixels of the imaging device is also full of variety, and also the filter arrangement of the imaging device is full of variety. Accordingly, there is a limit in the adaptive processing.

By the way, there is a video camera in which an exchange head for a still picture photography as well as an exchange head for a video photography is prepared, and when the exchange head for the video photography is mounted on a camera main frame, a recording for a dynamic picture image is performed on a video tape, and when the exchange head for the still picture photography is mounted on the camera main frame, a still picture image, which is subjected to JPEG compression, is recorded on a memory card of the exchange head instead of the video tape (cf. Japanese Patent Application Laid Open Gazette TokuKai 2004-40573).

Thus, it is considered to construct a camera system, in which a technology adopted in the above-mentioned video camera is applied to the above-mentioned camera system, and a plurality of sorts of camera heads is provided with a JPEG compression and expansion section, so that each camera head performs an image processing associated with the imaging device, and as a result, even if any sort of camera head is mounted on the camera main frame, it is possible to perform an adaptive image processing. However, it often happens that a display screen is provided at the end of the camera main frame, and thus there is a possibility that reproduction is impossible unless the camera head is mounted.

Further, in the event that the JPEG compression and expansion section is provided at the end of the camera head, it is obliged that a capacity of recording image is limited to a predetermined maximum value so that an image is recorded in a predetermined recording area, that is, a so-called fixed-length formalization is performed at the side of the camera head and then the image is recorded on a recording medium. Performing the fixed-length formalization makes it possible that the number of recording sheets for a photographic image, which is recorded on a recording medium, for example, a memory card, that is, the number of films is fixed.

However, as mentioned above, in the event that as the imaging device is full of variety, there appear various types of ones which are mutually different in the number of pixels and an arrangement of color filters, so that the variation of the number of pixels for each imaging device becomes larger as compared with the conventional one, there is a possibility of an occurrence of such a situation that the signal processing section and the JPEG compression and expansion section, which are provided on the camera head, simply perform a compression processing up to the capacity exceeding the recording area of the recording medium, even if it is intended to cause the signal processing section and the JPEG compression and expansion section to perform the fixed-length formalization as it is.

### SUMMARY OF THE INVENTION

In view of the foregoing, it is an object of the present invention to provide a camera system capable of performing fixed-length formalization independently of the side of the camera head even when any camera head is mounted on a camera main frame, a camera main frame constituting the camera system and operable in a single unitary body, and a camera head to be mounted on the camera main frame.

To achieve the above-mentioned objects, the present invention provides a camera system having a plurality of sorts of camera heads each comprising an image taking optical system and an imaging device, which generates an image signal, the camera heads being different from one another in specification of the imaging device, and a camera main frame for receiving the image signal from the camera head that is mounted on an exchangeable basis to perform an image recording processing for a recording medium, and/or to perform an image display processing for an image display screen, the camera head comprising:
a format conversion section that converts a first image signal, which is obtained by the imaging device provided on the camera head, into a second image signal of a predetermined format independent of dependence upon sorts of the camera head; and
an image transmission section that transmits the second image signal obtained in the format conversion section to the camera main frame; and
the camera main frame comprising:
an image receiving section that receives the second image signal transmitted from the image transmission section; and
an image processing section that performs the image recording processing and/or the image display processing in accordance with the second image signal received by the image receiving section.

According to the camera system of the present invention as mentioned above, the format conversion section converts the first image signal into the second image signal of a predetermined format independent of dependence upon sorts of the camera head. And thus even if anyone of the sorts of the camera heads is concerned, the second signal has the same format. This feature makes it possible to implement a camera system capable of performing a fixed-length formalization at the camera main frame regardless of the side of the camera head even if any of the camera heads is mounted on the camera main frame.

In the camera system according to the present invention as mentioned above, it is preferable that the format conversion section includes a compression processing section that generates a second image signal which is subjected to a compression processing into a predetermined format, and
the image processing section includes a thawing processing section that thaws the second image signal to generate a third image signal, and displays on the image display screen an image according to the third image signal obtained by the thawing section.

For example, assuming that the predetermined format of second image signal is obtained in such a way that the compression processing section applies the compression processing for the image signal into the predetermined format, it is possible that the compression section of the JPEG compression and expansion section, which is mounted on the conventional digital camera, is provided on the camera head and thereby can be used as the compression processing section, and the expansion section of the JPEG compression and expansion section is provided on the camera main frame and thereby can be used as the thawing processing section.

This feature makes it possible to simply construct the compression processing section and the thawing processing section in accordance with the conventional technology. Thus, even if any type of camera head is concerned, the mounted camera head transmits the second image signal of a predetermined format, which is subjected to the compression processing by the compression processing section, and the image processing section thaws the second image signal to generate a third image signal, so that an image based on the third image signal is displayed on the image display screen.

Thus, according to the present invention, it is possible to implement a camera system in which even if any type of the camera head is mounted on the camera main frame, when the power supply of the camera system is turned on, there is displayed on the image display screen the subject according to the image signal generated by the imaging device of the mounted camera head, and the photography standby condition is offered.

In the camera system according to the present invention as mentioned above, it is preferable that the format conversion section includes a compression processing section that generates a second image signal which is subjected to compression processing to a predetermined format, and
the image processing section includes a thawing processing section that thaws the second image signal to generate a third image signal, a signal processing section that applies to the third image signal a signal processing independent of dependence upon sorts of the camera head so as to generate a fourth image signal, and a second compression processing section that applies a compression processing to the fourth image signal to generate a fifth image signal, and the image processing section records the fifth image signal onto a recording medium.

According to the feature of the present invention as mentioned above, when the camera main frame receives the second image signal from the camera head in accordance with the photographic operation, it is possible that the second compression processing section applies a compression processing to the fourth image signal to generate a fifth image signal, and the image processing section records the fifth image signal onto a recording medium. Assuming that the second image signal is different from the fifth image signal in the compression condition, it is possible to record the fifth image signal onto a recording medium after the fifth image signal is created in the compression rate designated by a photographic operator for instance and the fixed-length formalization is carried out.

To achieve the above-mentioned objects, the present invention provides a camera head adopted in a camera system having a plurality of sorts of camera heads each comprising an image taking optical system and an imaging device, which generates an image signal, the camera heads being different from one another in specification of the imaging device, and a camera main frame for receiving the image signal from the camera head that is mounted on an exchangeable basis to perform an image recording processing for a recording medium, and/or to perform an image display processing for an image display screen, the camera head comprising:
a format conversion section that converts a first image signal, which is obtained by the imaging device provided on the camera head, into a second image signal of a predetermined format independent of dependence upon sorts of the camera head; and
an image transmission section that transmits the second image signal obtained in the format conversion section to the camera main frame.

According to the camera head of the present invention as mentioned above, a predetermined format of second image signal is transmitted from the camera head to the camera main frame. This feature makes it possible to use a normalized signal as the output signal of the camera head. Thus, a provision of the camera main frame capable of performing an image processing for the output signal of the camera head makes it possible to implement the camera head capable of being mounted on the camera main frame.

In the camera head according to the present invention as mentioned above, it is preferable that the format conversion section includes a compression processing section that generates a second image signal which is subjected to a compression processing into a predetermined format.

This feature makes it possible to use an arrangement in which the compression section of the JPEG compression and expansion section is provided on the camera head.

Here, it is preferable that the compression processing section performs the compression corresponding to the least compression rate and then outputs the signal, which is subjected to the JPEG compression, in form of the second image signal.

This feature makes it possible to transmit an image signal having a certain degree of capacity in form of the second image signal. And thus, it is possible to record the image signal onto a recording medium after the fixed-length formalization is carried out in such a manner that the camera main frame performs the image processing again.

To achieve the above-mentioned objects, the present invention provides a camera main frame that receives an image signal from any one of a plurality of sorts of camera heads each comprising an image taking optical system and an imaging device, which generates an image signal, the camera heads being different from one another in specification of the imaging device, the camera head being mounted on an exchangeable basis to perform an image recording processing for a recording medium, and/or to perform an image display processing for an image display screen, the camera head comprising:
a format conversion section that converts a first image signal, which is obtained by the imaging device provided on the camera head, into a second image signal of a predetermined format independent of dependence upon sorts of the camera head; and
an image transmission section that transmits the second image signal obtained in the format conversion section to the camera main frame; and
the camera main frame comprising:
an image receiving section that receives the second image signal transmitted from the image transmission section; and
an image processing section that performs the image recording processing and/or the image display processing in accordance with the second image signal received by the image receiving section.

In the camera main frame according to the present invention as mentioned above, it is preferable that the format conversion section includes a compression processing section that generates a second image signal which is subjected to a compression processing into a predetermined format, and
the image processing section includes a thawing processing section that thaws the second image signal to generate a third image signal, and displays on the image display screen an image according to the third image signal obtained by the thawing section.

Assuming that the format conversion section includes a compression processing section that generates a second image signal which is subjected to a compression processing into a predetermined format, and the compression processing section is the JPEG compression and expansion section, it is possible to readily obtain the third image signal in such a way that an image signal, which is subjected to the compression section of the JPEG compression and expansion section, is transmitted in form of the second image signal to the camera main frame so that the expansion section of the JPEG compression and expansion section thaws the second image signal.

According to the present invention, for example, in the event that a signal representative of the subject caught by the camera, which is subjected to the JPEG compression processing, is transmitted in form of the second image signal from the camera head to the camera main frame for each a predetermined time, it is possible that the image processing section generates the third image signal from the second image signal for each a predetermined time so that an image based on the third image signal is displayed in form of the dynamic image on the image display screen. Further, in the event that the image signal recorded on the recording medium is a type of the second image signal, it is possible that the image processing section generates the third image signal so that a reproduction image is displayed on the image display screen.

This feature makes it possible to implement a camera main frame that is operative as the structural element of a part of the image taking system when the camera head is mounted, and also to implement the camera main frame operative in united body, which is capable of performing the reproduction display without mounting the camera head on the camera main frame.

In the camera main frame according to the present invention as mentioned above, it is preferable that the format conversion section includes a compression processing section that generates a second image signal which is subjected to compression processing to a predetermined format, and
the image processing section includes a thawing processing section that thaws the second image signal to generate a third image signal, a signal processing section that applies to the third image signal a signal processing independent of dependence upon sorts of the camera head so as to generate a fourth image signal, and a second compression processing section that applies a compression processing to the fourth image signal to generate a fifth image signal, and the image processing section records the fifth image signal onto a recording medium.

According to the camera main frame of the present invention, when the camera main frame receives the second image signal from the camera head in accordance with the photographic operation, it is possible that the second compression processing section applies the compression processing to the fourth image signal to generate the fifth image signal of the fixed-length formalization, so that the fifth image signal is recorded on the recording medium. Assuming that the second image signal is different from the fifth image signal in the compression condition, it is possible to record the fifth image signal onto a recording medium after the fixed-length formalization for the fifth image signal is carried out in the compression rate designated by a photographic operator for instance.

### BRIEF DESCRIPTION OF THE DRAWINGS

FIG. 1 is a view of a camera system according to an embodiment of the present invention.

FIG. 2 is a perspective view of a camera system 1 in which a camera head 1a is mounted on a camera main frame 1b on an exchangeable basis.

FIG. 3 is a block diagram of an electric system in a state that a camera head 1a is mounted on a camera main frame 1b.

FIG. 4 is a view of the internal structure of a digital signal processing section of the camera main frame.

FIG. 5 is a view of a display screen of a set up mode.

FIG. 6 is an explanatory view useful for understanding a compression specification of a compression rate “fine”.

FIG. 7 is an explanatory view useful for understanding a transfer of a processing procedure in which the mode is transferred from the set up mode to a photographic mode, and up to performing photography in the photographic mode.

FIG. 8 is an explanatory view useful for understanding a procedure of the reproduction.

### DETAILED DESCRIPTION OF PREFERRED EMBODIMENTS

Embodiments of the present invention will be described with reference to the accompanying drawings.

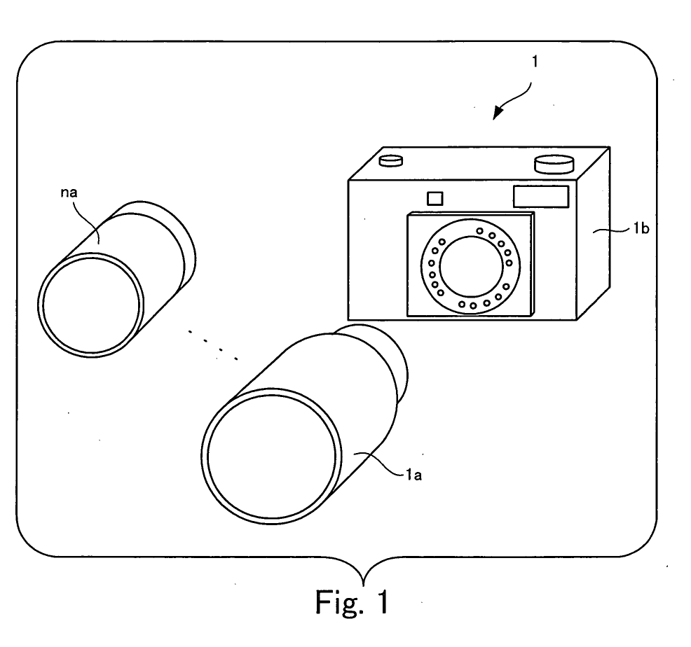

FIG. 1 is a view of a camera system according to an embodiment of the present invention.

FIG. 1 shows a camera system 1 having a plurality of sorts of camera heads 1a to na each comprising an image taking optical system and an imaging device, which generates an image signal, the camera heads being different from one another in specification of the imaging device, and a camera main frame 1b for receiving the image signal from the camera head that is mounted on an exchangeable basis to perform an image recording processing for a recording medium, and/or to perform an image display processing for an image display screen.

In the following explanation of the camera system 1, it is assumed that the camera system 1 is constructed in such a manner that one camera head 1a of the plurality of sorts of camera heads 1a to na is mounted on the camera main frame 1b on an exchangeable basis.

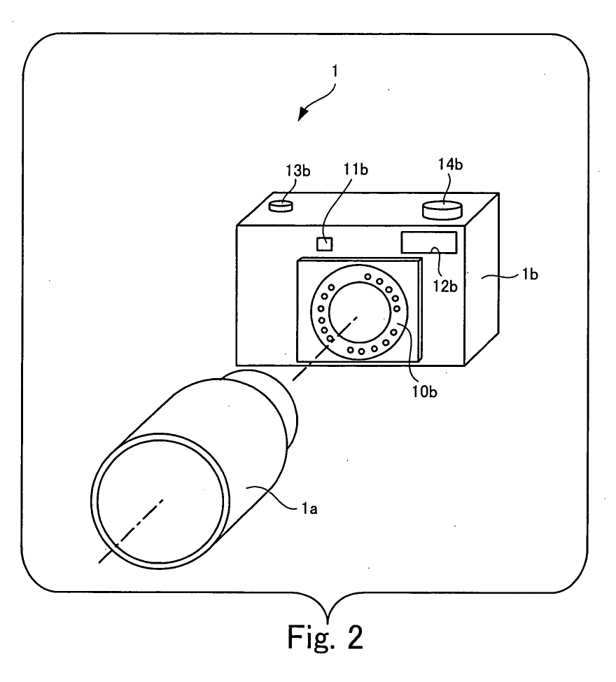

FIG. 2 is a perspective view of the camera system 1 in which the camera head 1a is mounted on the camera main frame 1b on an exchangeable basis.

FIG. 2 shows a state just before the camera head 1a, which comprises the image taking optical system and the imaging device, is detachably mounted on the camera main frame 1b that receives an image signal from the camera head 1a to perform an image processing.

As shown in FIG. 2, at the center of the camera main frame 1b there is provided a head mount 10b having a large number of mount contacts. Also at the side of the camera head 1a there is provided the similar mount section. When the camera head 1a is mechanically mounted on the camera main frame 1b along the dashed line in such a manner that positions of the mount contacts of both the camera main frame 1b and the camera head 1a meet one another, the mount contacts of both the camera main frame 1b and the camera head 1a are connected to one another so that the camera main frame 1b and the camera head 1a are electrically connected to each other.

In the camera system 1, the camera main frame 1b is provided with a battery, which supplies an electric power to the camera main frame 1b and also supplies the electric power to the camera head 1a via for electric power use contacts of the large number of mount contacts of the camera main frame 1b and the camera head 1a. When the electric power of the battery of the camera main frame 1b is supplied via the electric power use contacts to the camera head, both the camera main frame 1b and the camera head 1a offer the operative state.

At the top of the body of the camera main frame 1b, there are disposed a release button 13b and a mode dial 14b. When a photographic mode is selected by the mode dial 14b and the release button 13b is depressed, photography is carried out. The mode dial 14b is involved in items of a reproduction mode and a power source switch as well as the photographic mode, so that one of those items is selected through a rotary operation of the mode dial 14b. In front of the camera main frame 1b, there are provided an AWB sensor 11b and a flash light emission window 12b.

Here, there will be explained the internal structure of the camera main frame 1b and the camera head 1a.

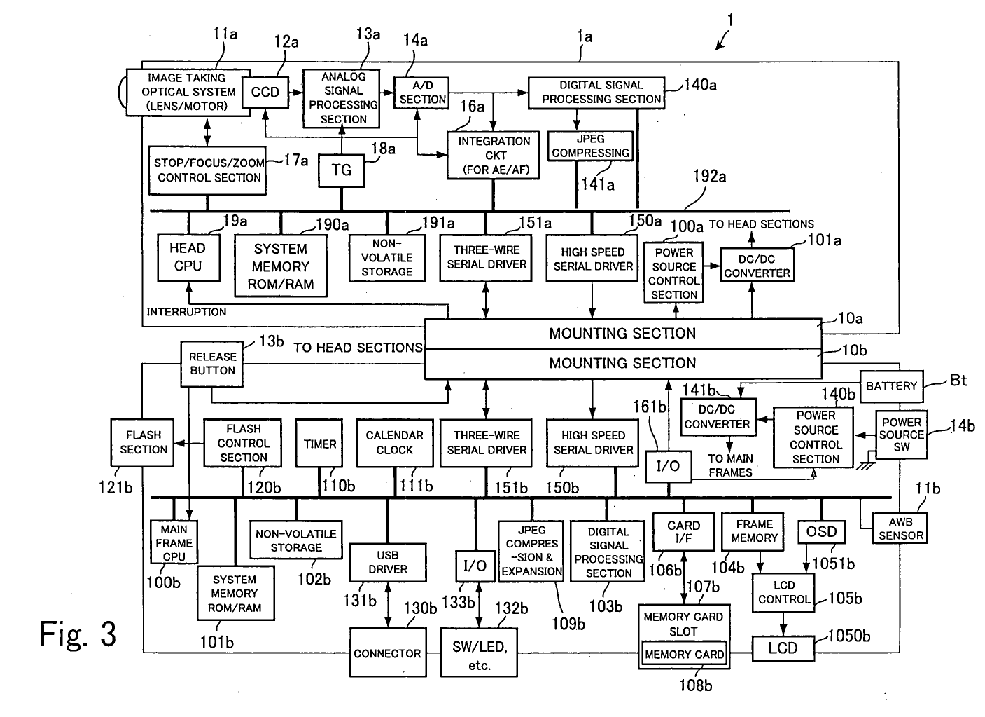

FIG. 3 is a block diagram of an electric system in a state that the camera head 1a is mounted on the camera main frame 1b.

In FIG. 3, the upper stage and the lower stage show the structure of the camera head 1a and the structure of the camera main frame 1b, respectively.

First, there will be explained the structure of the camera head 1a.

The camera head 1a, which constitutes the camera system 1 of the present embodiment, is operative when it is mounted on the camera main frame 1b so that an electric power is supplied from the battery Bt of the side of the camera main frame 1b. Here, it is assumed that the camera head 1a is mounted on the camera main frame 1b.

As shown in FIG. 3, the camera head 1a, which is mounted on the camera main frame 1b, is provided with an image taking optical system 11a and an imaging device 12a (hereinafter, it is referred to as CCD 12a since a CCD solid state imaging device is used). The image taking optical system 11a comprises an image taking lens and an aperture. A subject is formed on the CCD 12a by the image taking lens of the image taking optical system 11a so that the CCD 12a generates image data. The image data generated in the CCD 12a is fed to an analog signal processing section 13a so that the analog signal processing section 13a performs the processing for noise reduction. Thereafter, an A/D section 14a converts the image signal of an analog signal into the image signal of a digital signal. The image signal converted into the digital signal is fed to a digital signal processing section 140a to apply a signal processing according to a configuration of the CCD 12a of the camera head 1a. The image signal, which is subjected to the signal processing, is fed to a JPEG compression section 141a to perform the JPEG compression, and the image signal subjected to the JPEG compression processing is fed to a high speed serial driver 150a. The JPEG compression section 141a corresponds to the format conversion section referred to in the present invention, and the image signal subjected to the JPEG compression processing in the JPEG compression section 141a corresponds to the second image signal referred to in the present invention.

Of the image signals subjected to the JPEG compression processing, which is fed via the high speed serial bus to the camera main frame 1b, there are three types of image signals of: a through image use of image signal (hereinafter it is referred to as a through image signal) for displaying on an LCD panel (not illustrated) a subject caught by the image taking lens of the image taking optical system when the mode dial 14b selects any one of the photographic modes; an image signal (hereinafter it is referred to as a still picture image signal) indicative of a still picture that is obtained by the operation of the release button 13b when the mode dial 14b selects a still picture photographic mode of the photographic modes; and an image signal (hereinafter it is referred to as a dynamic picture image signal) indicative of a dynamic picture that is obtained by the operation of the release button 13b when the mode dial 14b selects a dynamic picture photographic mode of the photographic modes. Any one of those image signals is transmitted on a compressed state via the high speed serial bus to the camera main frame 1b in accordance with a request from the camera main frame 1b.

On the other hand, the image signal, which is converted into the digital signal by the A/D section 14a, is also fed to an integration circuit 16a. The integration circuit 16a has an AF function (hereinafter it is referred to as AF) and an AE function (hereinafter it is referred to as AE). The use of the integration circuit 16a performs a measurement for brightness of field to implement the AE function and a measurement for a subject distance to implement the AF function. The subject distance and the brightness of field, which are measured by the integration circuit 16a, are fed via a data bus 192a to a stop/focus/zoom control section 17a to control a diameter of a stop of the image taking optical system and to control a position of a focus lens of the image taking optical system. In this manner, whenever the lens of the image taking optical system of the camera head 1a is directed to different subjects, the AF and the AE operate to control the focus and the brightness so that the CCD 12a generates and outputs image data representative of the subject being in focus.

The CCD 12a, the analog signal processing section 13a, the A/D section 14a, and the integration circuit 16a are operative in synchronism with a timing signal from a timing generator (hereinafter it is referred to as TG) 18a. A CPU 19a controls the TG 18a. The CPU 19a controls the TG 18a and the stop/focus/zoom control section 17a in accordance with the procedure of the program stored in a system memory 190a. The system memory 190a stores therein software as to a processing procedure for initialization, a processing procedure for AE and AF, and a processing procedure related to the communication in the serial bus. Of the software mentioned above, there are such types of software, for example, software related to the through image processing actuated when the photographic mode and the still picture photographic mode are selected by the mode dial 14b, software related to the still picture image processing, and software related to the dynamic image processing actuated when the dynamic picture photographic mode is selected. The head CPU 19a controls the initialization of the camera head and the signal processing operation of the associated sections after the initialization of the camera head in accordance with the processing procedure described in those types of software. The operations of the associated sections include the operation of the signal processing section, the operation of the integration circuit 16a, the operation of the TG 18a, the read/write operation of a non-volatile storage 191a, the operation of a three-wire serial driver 151a, and the operation of a high speed serial driver 150a.

The non-volatile storage 191a stores therein configuration information for the camera head 1a. Each of the camera head 1a and the camera main frame 1b is provided with a three-wire serial driver 151b for driving a three-wire serial bus. A command is communicated between the camera head 1a and the camera main frame 1b via the serial bus that is driven by the drivers of the camera head 1a and the camera main frame 1b. For example, in the event that a command corresponding to the request for a transmission of the through image signal and the still picture image signal or the dynamic picture image signal is transmitted from the camera main frame 1b via the three-wire serial bus, the image signal, which is subjected to the JPEG compression, is transmitted to the camera main frame 1b via the high speed serial bus that is higher than the three-wire serial bus.

The above-mentioned description is concerned with the structure of the camera head 1a.

Next, there will be described the structure of the camera main frame 1b.

The camera main frame 1b is controlled by the CPU 100b at the side of the camera main frame 1b in a similar fashion to the camera head. At the side of the camera main frame 1b, there is provided a system memory 101b for storing software indicative of the processing procedure of the initialization.

As mentioned above, the image signal, which is transmitted from the camera head side via the high speed serial bus, is received by a high speed serial driver 150b that is controlled by the CPU 10b, and the received image signal is fed to a JPEG compression and expansion section 109b to expand the image signal that is subjected to the JPEG compression. The high speed serial driver 150b corresponds to the image receiving section referred to in the present invention, and the expansion section of the JPEG compression and expansion section 109b and a signal processing section 103b (which will be described later) correspond to the image processing section referred to in the present invention.

According to the present embodiment, the camera main frame 1b receives from the camera head 1a any one of the three sorts of image signals of the through image signal, the still picture image signal, and the dynamic picture image signal. For example, if the through image signal is concerned, the through image signal is subjected to the JPEG compression, and thus the JPEG compression and expansion section 109b of the camera main frame expands the JPEG-compressed through image signal and supplies the expanded image signal to the signal processing section 103b to convert the through image signal for the display. The through image signal for the display is stored in a frame memory 104b. An LCD control section 105b reads the through image signal stored in the frame memory 104b to display a through image based on the through image signal on an LCD panel of an LCD 1050b. The LCD 1050b also receives information from the side of an OSD (On Screen Display) 1051b. On the LCD screen, there are displayed a selection menu as well as the through image.

The camera main frame 1b further comprises: a timer 110b and a calendar clock 111b for creating data for displaying time and date information on the LCD screen via the OSD 1051b; a USB driver 131b and a USB connector 130b for connection with an external equipment; and a switch/LED 132b for giving an operational instruction. The operational instruction by the switch is fed via an I/O 133b to the main frame CPU 100b to perform the processing according to the operational instruction. The release button 13b is directly connected to both the interruption terminals of the main frame CPU 100b and the head CPU 19a. And thus, when the release button 13b is depressed, both the main frame CPU 100b and the head CPU 19a are subjected to the interruption so that the still picture image processing program or the dynamic picture image program are actuated.

Incidentally, an electric power is supplied from the battery Bt of the camera main frame 1b via a DC/DC converter 141b of the camera main frame 1b to the associated sections of the camera main frame 1b, and also the electric power is supplied from the battery Bt via a DC/DC converter 101a of the camera head 1a to the associated sections of the camera head 1a. The DC/DC converter 101a and the DC/DC converter 141b are controlled by a power source control section 100a and a power source control section 140b, which are provided on the camera head 1a and the camera main frame 1b, respectively. When a selection of the power source is indicated to the power source control section 140b in accordance with the operation of the mode dial 14b, an output instruction is issued from the power source control section of the main frame side to the DC/DC converter of the main frame side, and also the output instruction is issued via an I/O 161b to the power source control section 100a of the camera head 1b so that the electric power is supplied from the DC/DC converter 101a to the associated sections of the head.

Here, there will be shown the internal structure of the signal processing section 103b, which corresponds to a part of the image processing section, and there will be described how the signal processing section 103b performs the processing.

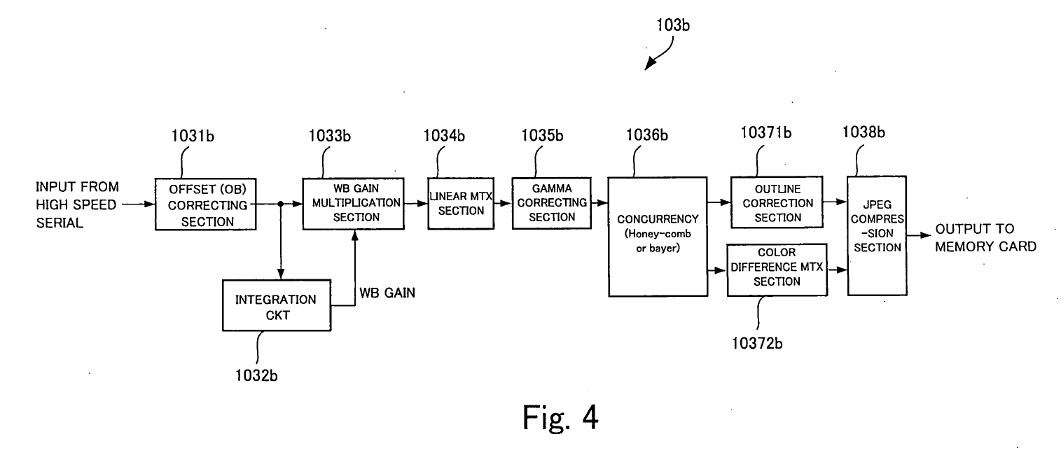

FIG. 4 is a view of the internal structure of the digital signal processing section 103b of the camera main frame.

When the digital signal processing section 103b receives any one of the through signal, the still picture signal and the dynamic picture signal, which are compressed, from the mounted camera head 1a via the high speed serial bus driven by the high speed serial driver, as mentioned above, a JPEG compression and expansion section 109b expands the compressed image signal. Then, the digital signal processing section 103b receives the expanded image signal to initiate the image processing.

For example, in the event that the through image signal is supplied to display a through image based on the through image signal on the panel of the LCD control section 105b, an adjustment of the dynamic range by an offset correction section 1031b, adjustments of gain of R-signal, G-signal and B-signal for obtaining white color of high purity by a WB gain multiplication section 1033b, conversion into YCrCb signal by a linear MTX section 1034b, and an adjustment of brightness by a gamma correction section 1035b are performed, and thereafter a YC signal is supplied to a frame memory 104b for each predetermined time so that an image based on the YC signal stored in the frame memory 104b is displayed on the LCD panel in form of the through signal. The YC signal stored in the frame memory 104b corresponds to the third signal referred to in the present invention.

When the release button 13b is depressed while an operator looks the through image, the still picture image signal, which is created in the CCD 12a, is fed to the JPEG compression and expansion section 109b in form of a JPEG compression signal so that the JPEG compression and expansion section 109b expands the JPEG compression signal. The thus expanded still picture image signal is fed to the signal processing section 103b. Then, the similar processing to that of through image signal is carried out by the offset correction section 1031b to the gamma correction section 1035b to generate YC signals. The YC signals are simultaneously separated by a concurrency section 1036b into two signals of a Y-signal and a color C-signal. The Y-signal and the color signal are fed to an outline correction section 10371b and a color difference MTX 10372b, respectively. The outline correction section 10371b performs an edge emphasis, and the color difference MTX 10372b converts the C-signal to a color difference signal, so that the Y-signal and the color difference signal are subjected to a JPEG compression processing by a JPEG compression section 1038b and then stored in a memory card. A part excepting the JPEG compression section 1038b from the signal processing section 103b corresponds to the signal processing section referred to in the present invention, and the JPEG compression section 1038b corresponds to the second compression section referred to in the present invention.

The WB gain multiplication section 1033b and an integration circuit 1032b are adapted to set the number of pixels designated in a set up mode (which will be described later) in form of a parameter. The linear MTX section 1034b is adapted to set a matrix factor of a color conversion matrix in accordance with set up of tone and chroma saturation in form of a parameter. The outline correction section 10371b is adapted to set a matrix factor for the edge emphasis in accordance with set up of sharpness in form of a parameter. Thereafter the associated sections perform the processing.

In a similar fashion to that of still picture image signal, the dynamic image signal is also recorded via the same path as the still picture image signal to a memory card 108b mounted on a memory card slot 107b.

Thus, there is implemented a camera system capable of receiving an image signal from a camera head that is mounted on a camera main frame on an exchangeable basis to perform an image recording processing to a recording material (a memory card) at the camera main frame, and/or an image display processing for the image display screen.

In this manner, it is possible to implement a camera system capable of performing a suitable image processing at the side of the camera main frame even if any type of the camera head is mounted on the camera main frame.

Here, there will be explained set up modes for setting up parameters to the associated sections of the signal processing section at the side of the camera main frame.

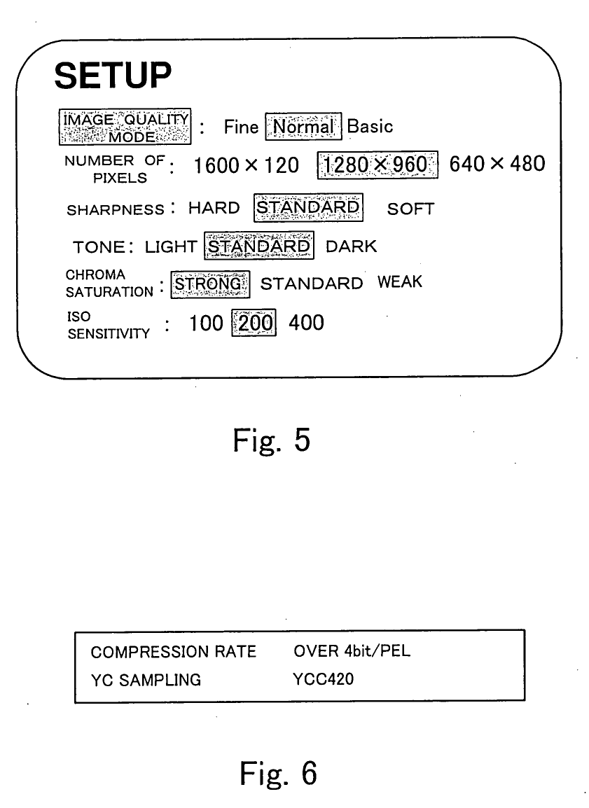

FIG. 5 is a view of a display screen of a set up mode.

As seen from FIG. 5, selection items are set in the order of image quality modes, the number of pixels, sharpness, tones, chroma saturation, and ISO sensitivity.

For example, when any one (for example, “Normal”) of the image quality modes is designated, the compression factor according to “Normal” is designated as a parameter on the JPEG compression section of the signal processing section. At that time, the main frame CPU performs a memory allocation for recording area of a recording medium (memory card) in accordance with the compression factor. For example, when the mode “Normal” is designated, the main frame CPU ensures a division area corresponding to the maximum value of data capacity of an image signal that is subjected to the JPEG compression in the compression rate (2 bits/pel) according to the mode “Normal”, and the JPEG compression section performs such a compression that a recording is carried out within the division area. Implementation of such a fixed-length formalization makes it possible that the number of photographic sheets is clear in the mode “Normal”, so that the recording area of the recording medium (memory card) can be effectively used, and also makes it possible to inform a user of a state that the recording area is occupied. However, when the mode “Fine” is selected, there is ensured a capacity of division area corresponding to the mode “Fine” (4 bits/pel). When the mode “Basic” is selected, there is ensured a capacity of division area corresponding to the mode “Basic” (1 bit/pel). Thus, the number of photographic sheets in the mode “Normal”, the number of photographic sheets in the mode “Fine”, and the number of photographic sheets in the mode “Basic” are mutually different from one another.

When the number of pixels is designated, there is selected a size as to whether pixels of 1280×960 are used to form a fine image, or pixels of 640×480, that is, the half of 1280×960, are used to form the associated image.

When the sharpness, the tone and the chroma saturation are set up, the matrix factor of the color conversion matrix, which is set up to the linear MTX section 1034b, and the correction value of the outline correction section 10371b are altered.

Finally, with respect to the ISO sensitivity, since it is obliged to have the pixel mixing according to the number of pixels of the imaging device at the time of output, it is informed the side of camera head via a three-wire serial interface.

In this manner, a predetermined format of image signal is supplied from the camera head to the side of the camera main frame. This feature makes it possible that the signal processing section of the camera main frame performs the image process according to the set up regardless of the camera head.

Further, according to the present embodiment, when a predetermined format of second image signal is transmitted from the camera head to the camera main frame, it is utilized that an amount of data is largest in the event that the compression is performed at the compression rate in the mode “Fine”, and an image signal, which is subjected to the compression processing in the compression specification of the mode “Fine”, is expressed in form of the second image signal.

FIG. 6 is an explanatory view useful for understanding a compression specification of a compression rate “fine”.

An image signal, which is subjected to the compression processing in accordance with the compression specification shown in FIG. 6, is transmitted in form of the second image signal from the camera head to the camera main frame.

Thus, an expression of the compression specification of a compression rate with a predetermined format makes it possible to readily generate a predetermined format of second image signal using the compression section of the JPEG compression and expansion sections with which a digital camera is always provided.

Finally, there will be explained a flow of an image signal from a procedure that the set up mode is actuated in the camera system and the photography is carried out up to a procedure that the image signal is recorded on a memory card, with reference to a communication between the side of the camera main frame and the camera head.

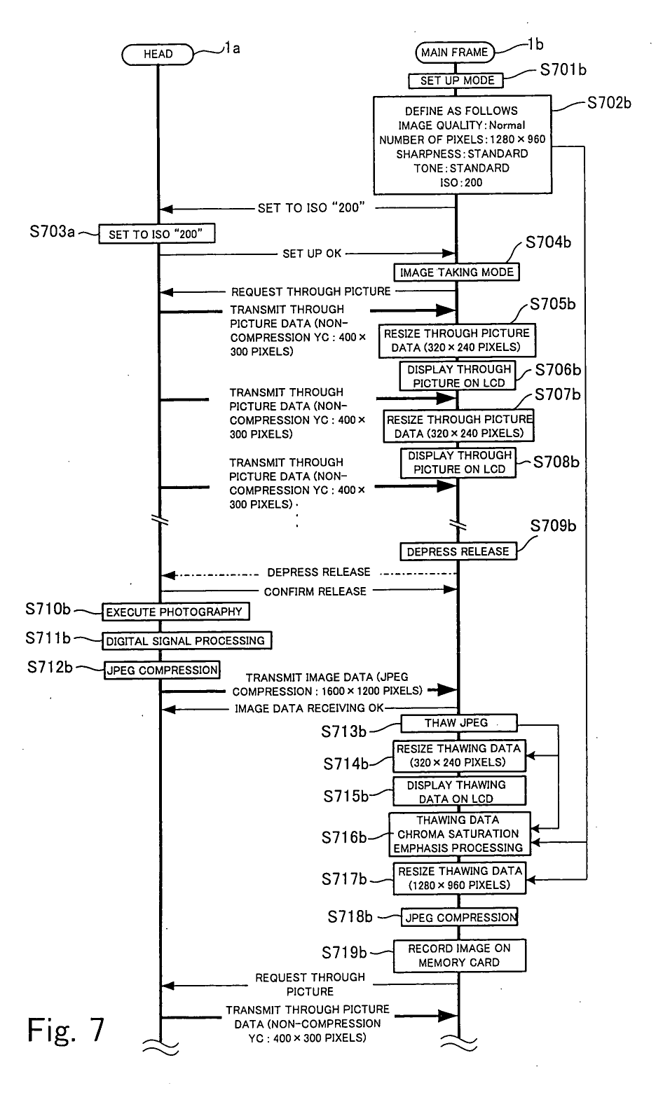

FIG. 7 is an explanatory view useful for understanding a transfer of a processing procedure in which the mode is transferred from the set up mode to a photographic mode, and up to performing photography in the photographic mode.

It is noted that a mark “b” is applied to the end of the respective processing step of the side of the camera main frame in order to clarify such a matter that it is concerned with the processing of the side of the camera main frame, and in similar fashion, a mark “a” is applied to the end of the respective processing step of the side of the camera head in order to clarify such a matter that it is concerned with the processing of the side of the camera head. In FIG. 7, contents of communications between the camera main frame 1b and the camera head 1a are written by letters, and a transmission direction of the contents written by letters is indicated by an arrow.

In the side of the main frame and the side of the head, the main frame CPU and the head CPU implement the associated processing steps, respectively.

In step S701b, a Set Up mode is activated so that a display screen of the set up mode shown in FIG. 5 is displayed on the LCD panel. When a set up as shown in step S702b (in FIG. 5 the setup items are encircled with a frame) is completed, first, ISO sensitivity (in FIG. 5 ISO sensitivity 200) is informed from the camera main frame 1b via a three-wire serial interface to the camera head 1a.

Upon receipt of this information, step S703a sets to the analog signal processing section 13a the gain for amplitude regulation to implement the ISO sensitivity 200, or sets the same to the digital signal processing section 140a. In this manner, after the step S703a sets the gain so as to perform the signal processing according to the ISO sensitivity, the head CPU 19a transmits a reply of set-up OK via the three-wire serial interface to the camera main frame 1b.

Then, in step S704b, a still picture photographic mode program stored in the system memory is activated to inform the camera head 1a of a transmission request for a through image via the three-wire serial interface. Upon receipt of this information, the camera head 1a transmits to the side of the camera main frame 1b the through image signal of the number of pixels of 400×300 in a state of the non-compression through the high speed serial interface in the condition that the through image signal is compressed in the format of “fine”. In step S705b, the signal processing section resizes the through image signal into an image signal of the number of pixels of 320×240 in order to form a signal for a display of the LCD panel. The resized image signal is stored in a frame memory so that an image is displayed on the LCD panel in accordance with the image signal stored in the frame memory.

Hereinafter, as shown in steps S707b to S708b, the similar processing is repeated every a predetermined time.

In step S709b, when the release button is depressed, an interruption signal is fed to both the CPU's to activate the respective still picture image processing programs of both the system memories.

In step S710b, a timing generator is controlled to cause the CCD 12a to output the image signal, which is obtained at the time of depression of the release button, after the exposure is terminated. The thus outputted image signal is fed to the analog signal processing section 13a, the A/D section 14a, and the digital signal processing section 140a. The signal, which is subjected to the signal processing by the digital signal processing section 140a, is subjected to the compression processing by the JPEG compression section 141a, and the signal subjected to the compression processing is transmitted via the high speed serial bus to the camera main frame. Upon receipt of the JPEG compression signal, the main frame CPU of the camera main frame transmits an image data receiving acceptance signal OK via the three-wire serial bus to the camera head.

Thereafter, in step S713b, the JPEG compression and expansion section 109b performs a JPEG thawing. In step S714b, the signal processing section 103b performs a resize processing for an image signal of a pixel size of 1800×1200 into an image signal of a pixel size of 320×240. In step S715b, the image signal subjected to the resize processing is stored in the frame memory 104b. An image based on the image signal stored in the frame memory 104b is displayed on the LCD panel under the control of the LCD control section. In step S716b, the thawed image signal is fed to the linear MTX section 1034b of the signal processing section 103b to set the color conversion matrix so as to perform the control of the chroma saturation.

After the processing for the chroma saturation is completed, in step S717b, the signal processing section 103b resizes the image signal into a size to meet the number of pixels designated in the set up mode. In step S718b, the JPEG compression section 1038b of the signal processing section 103b compresses the image signal so as to be recorded in a predetermined recording area. In step S719b, the compressed image signal is recorded on the memory card 108b. In this manner, when the recording of the image signal is terminated, the process returns to the step S704b to repeat the processing.

The above-mentioned description is concerned with the procedure related to the processing of the through picture image signal and the processing of the still picture image signal.

As mentioned above, according to the present embodiment, even if any type of camera head 1a is mounted on the camera main frame 1b, it is possible to implement a camera system capable of performing at the side of the camera main frame a suitable image processing regardless of the camera head, upon receipt of the second image signal transmitted from the camera head mounted on the camera main frame.

Further, according to the present embodiment, it is possible to reproduce with a unit of the camera main frame without mounting the camera head.

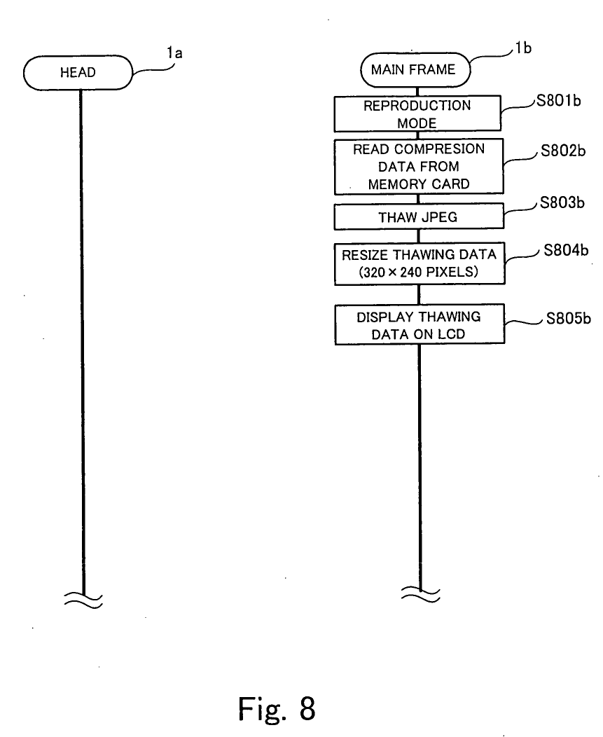

FIG. 8 is an explanatory view useful for understanding a procedure of the reproduction.

In step S801b, a mode dial 14b of the camera main frame is used to select a reproduction mode. In step S802b, the image signal, which is subjected to the compression procession, is read from the memory card to the camera main frame. In step S803b, the JPEG compression and expansion section 109b of the camera main frame performs the JPEG thawing. In step S804b, the signal processing section 103b resizes the thawed image signal and supplies the same to the frame memory 104b. In step S805b, an image is displayed on the LCD panel in accordance with the image signal stored in the frame memory 104b.

In this manner, it is possible to reproduce with a unit of the camera main frame without mounting the camera head according to the conventional manner.

As mentioned above, according to the present invention, it is possible to implement a camera system capable of performing fixed-length formalization independently of the side of the camera head even when any camera head is mounted on a camera main frame, a camera main frame constituting the camera system and operable in a single unitary body, and a camera head to be mounted on the camera main frame.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A camera system having a plurality of sorts of camera heads each comprising an image taking optical system and an imaging device, which generates an image signal, the camera heads being different from one another in specification of the imaging device, and a camera main frame for receiving the image signal from the camera head that is mounted on an exchangeable basis to perform an image recording processing for a recording medium, and/or to perform an image display processing for an image display screen, the camera head comprising:
a format conversion section that converts a first image signal, which is obtained by the imaging device provided on the camera head, into a second image signal of a predetermined format independent of dependence upon sorts of the camera head; and
an image transmission section that transmits the second image signal obtained in the format conversion section to the camera main frame; and
the camera main frame comprising:
an image receiving section that receives the second image signal transmitted from the image transmission section; and
an image processing section that performs the image recording processing and/or the image display processing in accordance with the second image signal received by the image receiving section.

2. A camera system according to claim 1, wherein the format conversion section includes a compression processing section that generates a second image signal which is subjected to a compression processing into a predetermined format, and
the image processing section includes a thawing processing section that thaws the second image signal to generate a third image signal, and displays on the image display screen an image according to the third image signal obtained by the thawing section.

3. A camera system according to claim 1, wherein the format conversion section includes a compression processing section that generates a second image signal which is subjected to compression processing to a predetermined format, and
the image processing section includes a thawing processing section that thaws the second image signal to generate a third image signal, a signal processing section that applies to the third image signal a signal processing independent of dependence upon sorts of the camera head so as to generate a fourth image signal, and a second compression processing section that applies a compression processing to the fourth image signal to generate a fifth image signal, and the image processing section records the fifth image signal onto a recording medium.

4. A camera head adopted in a camera system having a plurality of sorts of camera heads each comprising an image taking optical system and an imaging device, which generates an image signal, the camera heads being different from one another in specification of the imaging device, and a camera main frame for receiving the image signal from the camera head that is mounted on an exchangeable basis to perform an image recording processing for a recording medium, and/or to perform an image display processing for an image display screen, the camera head comprising:
a format conversion section that converts a first image signal, which is obtained by the imaging device provided on the camera head, into a second image signal of a predetermined format independent of dependence upon sorts of the camera head; and
an image transmission section that transmits the second image signal obtained in the format conversion section to the camera main frame.

5. A camera head according to claim 4, wherein the format conversion section includes a compression processing section that generates a second image signal which is subjected to a compression processing into a predetermined format.

6. A camera main frame that receives an image signal from any one of a plurality of sorts of camera heads each comprising an image taking optical system and an imaging device, which generates an image signal, the camera heads being different from one another in specification of the imaging device, the camera head being mounted on an exchangeable basis to perform an image recording processing for a recording medium, and/or to perform an image display processing for an image display screen, the camera head comprising:
a format conversion section that converts a first image signal, which is obtained by the imaging device provided on the camera head, into a second image signal of a predetermined format independent of dependence upon sorts of the camera head; and
an image transmission section that transmits the second image signal obtained in the format conversion section to the camera main frame; and
the camera main frame comprising:
an image receiving section that receives the second image signal transmitted from the image transmission section; and
an image processing section that performs the image recording processing and/or the image display processing in accordance with the second image signal received by the image receiving section.

7. A camera main frame according to claim 6, wherein the format conversion section includes a compression processing section that generates a second image signal which is subjected to a compression processing into a predetermined format, and
the image processing section includes a thawing processing section that thaws the second image signal to generate a third image signal, and displays on the image display screen an image according to the third image signal obtained by the thawing section.

8. A camera main frame according to claim 6, wherein the format conversion section includes a compression processing section that generates a second image signal which is subjected to compression processing to a predetermined format, and
the image processing section includes a thawing processing section that thaws the second image signal to generate a third image signal, a signal processing section that applies to the third image signal a signal processing independent of dependence upon sorts of the camera head so as to generate a fourth image signal, and a second compression processing section that applies a compression processing to the fourth image signal to generate a fifth image signal, and the image processing section records the fifth image signal onto a recording medium.
